(19) United States
(12) Patent Application Publication
(10) Pub. No.: US 2007/0291187 A1
(43) Pub. Date: Dec. 20, 2007

(54) Lcd Monitor-Integrated Digital Image Storage Device

(76) Inventor: Sang-Rak Lee, Daegu (KR)

Correspondence Address: PARK LAW FIRM, 3255 WILSHIRE BLVD, SUITE 1110, LOS ANGELES, CA, 90010, US

(21) Appl. No.: 10/586,012

(22) PCT Filed: Feb. 18, 2005
(86) PCT No.: PCT/KR05/00460

§ 371 Date: Jul. 14, 2006

(30) Foreign Application Priority Data
Feb. 19, 2004 (KR) 20-2004-0004278

(51) Int. Cl. H04N 3/14

(52) U.S. Cl. 348/790; 348/E03.011

(57) ABSTRACT

Provided is a digital image storage device integrated with an LCD monitor such that image processing and storage functions and Internet and TV functions are integrated in a stand alone type. The digital image storage device includes an image processor (13), a memory (14) and a HDD (15), which are required for processing and storing images, in addition to an LCD panel (10), a back light (11), and LCD driver (12), which are components of a conventional LCD monitor. A video signal of a wired camera (1) and a video signal of a wireless camera (2) through a wireless transceiver (2′) are converted into digital signals through an image pre-processor (16) and then input to the image processor (13).

### TECHNICAL FIELD

The present invention relates to a digital image storage device used for security purpose, and more particularly, to a digital image storage device integrated with an LCD monitor such that image processing and storage functions and Internet and TV functions are integrated in a stand alone type, to thereby simplify configuration, easily install and use the device and effectively use the device for security purpose.

### BACKGROUND ART

With the recent enhancement of interest in security, the necessity and demand for products related to security and image processing have been rapidly increased. However, a conventional image output device for security includes a monitor and units for processing and storing images, which are separately constructed and sold. To use the image output device for a security system, the monitor and image processing and storing units should be independently purchased and assembled. This requires high costs and restricts the use of the image output device. Furthermore, even a modem used for Internet access is an independent component so that it is difficult for a user to purchase the modem and connect it to the security system.

### DISCLOSURE OF INVENTION

Accordingly, the present invention integrates an image processing and storing device with an LCD monitor such that the image processing and storing device can be used semi-permanently with high resolution and its installation space and consumption power can be reduced. The LCD monitor-integrated image processing and storing device is constructed such that it can receive camera signals through wire or wirelessly to process the camera signals and an Internet chip is set in the device to enable Internet access without using an additional device. The LCD monitor-integrated image processing and storing device can be easily installed and used.

The present invention provides a digital image storage device integrated with an LCD monitor having an LCD panel, a back light and an LCD driver. An image processor, a memory and an HDD, required for processing and storing images, are set in a single main body and operated in connection such that a video signal of a wired camera and a video signal of a wireless camera via a wireless transceiver are converted into digital signals through an image pre-processor and input to the image processor. A microcomputer is set in the device to program and manage control signals including processing sequences. An Internet interface is connected to the image processor to use the Internet through TCP/IP. A TV tuner is connected between the microcomputer and the LCD driver to receive TV signals, and the microcomputer receives a signal of an IR remote control.

### BRIEF DESCRIPTION OF THE DRAWINGS

Further objects and advantages of the invention can be more fully understood from the following detailed description taken in conjunction with the accompanying drawings, in which:

FIG. 1 shows the configuration of a digital image storage device according to the present invention.

### BEST MODE FOR CARRYING OUT THE INVENTION

The present invention will now be described in detail in connection with preferred embodiments with reference to the accompanying drawings.

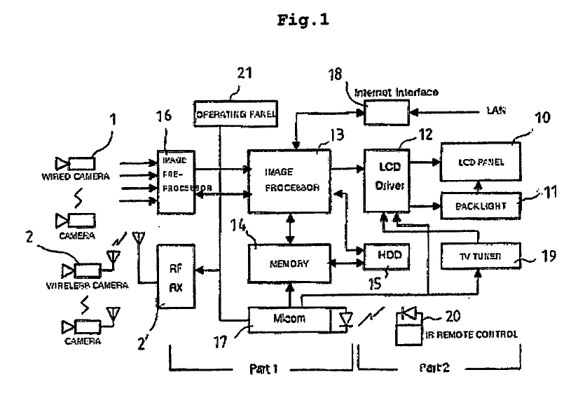

FIG. 1 shows the configuration of a digital image storage device according to the present invention. Referring to FIG. 1, the digital image storage device includes an image processor 13, a memory 14 and a HDD 15, which are required for processing and storing images, in addition to an LCD panel 10, a back light 11, an LCD driver 12, which are components of a conventional LCD monitor. The image processor 13, the memory 14 and the HDD 15 are set in a single main body such that they are operated in connection. A video signal of a wired camera 1 and a video signal of a wireless camera 2 through a wireless transceiver 2′ are converted into digital signals through an image pre-processor 16 and then input to the image processor 13. Furthermore, a microcomputer 17 is set in the device such that it programs and manages control signals such as a processing sequence. The microcomputer 17 transmits and receives the control signals and signals.

An Internet interface 18 is connected to the image processor 13 to use the Internet through TCP/IP. In addition, a TV tuner 19 is connected between the microcomputer 17 and the LCD driver 12 to receive TV signals. A remote control signal is input to the microcomputer 17 such that the TV tuner 19 can receive the signal of an IR remote control 20 to operate. The IR remote control 20 includes a TV/DVR select button. A TV signal is received when TV is selected using the TV/DVR select button while a camera image from the image processor 13 is selectively transmitted to the LCD driver 12 to be displayed when DVR is selected when DVR is selected.

A separable HDD is used as the HDD 15 such that its capacity and type can be changed if required. In FIG. 1, reference numeral 21 is an operating panel.

The operation of the digital image storage device of the present invention will now be explained.

A video signal captured by the wired camera 1 or a video signal captured by the wireless camera 2, selected by a user, passes through the image pre-processor 16 and then is processed and stored by the image processor 13, the memory 14 and the HDD 15. Here, the image processor 13 compresses the video signal and stores the signal in the HDD 15. Simultaneously, the image processor 13 delivers the video signal to the LCD panel 10 to display an image corresponding to the video signal in real time. Processing sequences and control signals of part 1 and part 2 shown in FIG. 1 are programmed and managed by the microcomputer 17. The microcomputer 17 also processes the control signal of the IR remote control 20.

A signal from the TV tuner 19 and a TV image from the microcomputer 17 are selectively transmitted to the LCD driver 12 by the IR remote control 20. The HDD 15 is separable so that its capacity and type can be easily changed.

The present invention supports both of the wired camera 1 and wireless camera 2. Thus, the microcomputer 17 processes pre-processing of images corresponding to wired or wireless input signals and RF reception.

### INDUSTRIAL APPLICABILITY

As described above, the present invention integrates the image processing and storing functions and TV and Internet connection functions in a stand alone type with the conventional LCD monitor to receive, process and store wired or wireless camera signals. The present invention can provide distinct images to the LCD monitor, reduce the number of components and simplify the manufacturing process to remarkably improve the performance in comparison to cost.

Furthermore, processed video signals are directly transmitted to the LCD monitor to improve signal efficiency, resulting in a decrease in the number of components and enhancement of picture quality. Moreover, the Internet chip is set in the device to facilitate Internet access without using an additional device. Therefore, a remote security system through the Internet, such as a remote control system and a remote monitoring system, can be constructed to improve the quality of security system.

While the present invention has been described with reference to the particular illustrative embodiments, it is not to be Restricted by the embodiments but only by the appended claims. It is to be appreciated that those skilled in the art can change or modify the embodiments without departing from the scope and spirit of the present invention.

1. A digital image storage device integrated with an LCD monitor having an LCD panel 10, a back light 11 and an LCD driver 12,
wherein an image processor 13, a memory 14 and an HDD 15, required for processing and storing images, are set in a single main body and operated in connection such that a video signal of a wired camera 1 or a video signal of a wireless camera 2 via a wireless transceiver 2′ are converted into digital signals through an image pre-processor 16 and input to the image processor 13,
a microcomputer 17 is set in the device to program and manage control signals including processing sequences,
an Internet interface 18 is connected to the image processor 13 to use the Internet through TCP/IP, and
the microcomputer 17 receives a signal of an IR remote control 20.

2. The digital image storage device integrated with an LCD monitor as claimed in claim 1, wherein the HDD 15 is a separable from the device.
